(19) United States
(12) Patent Application Publication
(10) Pub. No.: US 2008/0162615 A1
(43) Pub. Date: Jul. 3, 2008

(54) Apparatus, method and computer program product providing user calendar interrupt button and function to automatically clear and re-schedule calendar events

(75) Inventors: Jussi Hurmola, Tampere (FI); Sampo J. Savolainen, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/647,983

(22) Filed: Dec. 28, 2006

(51) Int. Cl. G06F 9/44

(52) U.S. Cl. 708/112

(57) ABSTRACT

In one non-limiting aspect the exemplary embodiments provide a method that includes, in response to a user-generated input, operating a calendar application to access an electronic calendar to cancel at least one scheduled event; and generating information for use in contacting at least one party associated with the cancelled at least one scheduled event. The calendar application may also re-schedule the cancelled at least one event in the electronic calendar. The user-generated signal may result form the user activating a calendar interrupt function to automatically clear and re-schedule calendar events.

### TECHNICAL FIELD

The exemplary embodiments of this invention relate generally to user interfaces for devices and methods pertaining to same and, more specifically, relate to calendar-type and similar scheduling-capable and time management applications.

### BACKGROUND

An automated calendar application is typically used in a manner similar to that of a traditional list of reminders written into a book or other paper medium. Decision making and simple tasks are all manually determined and added to the calendar. The calendar is based on singleton events which are communicated through some invitation-type of explanation of an event content and time of occurrence.

Time is a resource that everyone understands and has access to. In the modern information community the amount of data can easily swamp an individual, hindering the individual's work performance and enjoyment of personal life. Information arranging systems have traditionally concerned mostly the information external to the person. However, in the information era one's personal information, and the management of that personal information, becomes an important factor in a person's effectiveness and independence. A personal resource that is often underrated or totally overlooked is Time.

As is noted by A. Niemi (Nokia Research Center) in Internet-Draft: Session Initiation Protocol Event Packages for Calendering, draft-niemi-sipping-cal-events-01, expired Sep. 7, 2006, calendar sharing enables a user to subscribe to receiving information of a specific remote calendar. This calendar can represent the calendar entries of a particular-user's daily schedule, or any other type of calendar information such as the release schedule of an open source software project.

Niemi discusses several preexisting standards, and works in progress, in the area of calendaring. Most notably, the Internet Scheduling Core Object Specification (iCalendar), (see Dawson, F. and Stenerson, D., “Internet Calendaring and Scheduling Core Object Specification (iCalendar)”, RFC 2445, November 1998), the iCalendar Transport-Independent Interoperability Protocol (iTIP), (see Silverberg, S., Mansour, S., Dawson, F., and R. Hopson, “iCalendar Transport-Independent Interoperability Protocol (iTIP) Scheduling Events, BusyTime, To-dos and Journal Entries”, RFC 2446, November 1998), define the data format, and its binding to Internet email (see Dawson, F., Mansour, S., and S. Silverberg, “iCalendar Message-Based Interoperability Protocol (iMIP)”, RFC 2447, November 1998).

RFC 3265 (Roach, A., “Session Initiation Protocol (SIP)-Specific Event Notification”, June 2002) defines an event subscription and notification framework that can be used to subscribe to different types of events related to SIP systems. A publication counterpart, defined in RFC 3903 (Niemi, A., “Session Initiation Protocol (SIP) Extension for Event State Publication”, RFC 3903, October 2004), allows for a SIP user agent to publish event state into a central compositor that then distributes this information to the subscribers of that event package.

The Niemi Internet draft (draft-niemi-sipping-cal-events-01) defines two new event packages for calendaring events; the first allows sharing of calendar events and the second enables scheduling events related to calendaring. Using these two event packages there is defined, in effect, an iTIP mapping to SIP.

Niemi defines several related concepts as follows: Calendar User Agent: a SIP user agent that acts on the behalf of the calendar user, Calendar Server: a SIP user agent responsible for accepting subscriptions and sending out notifications containing calendar data, Calendar Watcher: a SIP user agent responsible for issuing subscriptions and processing notifications of calendar events.

The background of calendar sharing and scheduling applications as summarized by Niemi as dating back several years. Especially in the enterprise domain, these applications have been commonplace for nearly a decade. Many enterprise collaboration tools have provided enterprise users with tools that enable calendar access, as well as the ability to schedule meetings and other calendar entries among the users.

Tools based on proprietary protocols have provided very little interoperability, and generally have not allowed inter-organizational calendar access. Being able to schedule meetings across organizations necessitates the availability of: interoperable data formats, interoperable sharing and scheduling protocols and reasonable means of access control and channel security.

The availability of the first is all but guaranteed at present. The iCalendar format and its predecessor, the vCalendar format (see Internet Mail Consortium, “vCalendar—The Electronic Calendaring and Scheduling Exchange Format”, http://www.imc.org/pdi/vcal-10.txt, September 1996) are nearly ubiquitous and supported currently by a majority of Personal Information Management (PIM) applications.

Some solutions for calendar sharing and scheduling have been available based on standard components, such as by being based on HTTP (see Fielding, R., Gettys, J., Mogul, J., Frystyk, H., Masinter, L., Leach, P., and T. Berners-Lee, “Hypertext Transfer Protocol—HTTP/1.1”, RFC 2616, June 1999) and WebDAV (see Goland, Y., Whitehead, E., Faizi, A., Carter, S., and D. Jensen, “HTTP Extensions for Distributed Authoring—WEBDAV”, RFC 2518, February 1999) extensions. Recent efforts have proposed CalDAV as a standard calendar access protocol based on WebDAV. Extending calendaring applications beyond a single administrative domain requires that the protocols allow reasonable means for user identification, authentication and access control.

One problem that can arise, but that is not addressed by currently known calendar applications, is that the calendar cannot respond to an occurrence of a negative event, even a simple one, to automatically and immediately reorganize a period in the calendar schedule. Examples of negative events can include the arrival of an unexpected visitor in the office, the arrival of an important message, or the user falling ill. In conventional practice the user needs to manually go through all of the calendar entries and move or cancel the affected events, as well as possibly notifying affected parties.

### SUMMARY OF THE EXEMPLARY EMBODIMENTS

The foregoing and other problems are overcome, and other advantages are realized, in accordance with the non-limiting and exemplary embodiments of this invention.

In accordance with the exemplary embodiments of this invention there is provided a method that includes, in response to a user-generated input, operating a calendar application to access an electronic calendar to cancel at least one scheduled event; and generating information for use in contacting at least one party associated with the cancelled at least one scheduled event.

Further in accordance with the exemplary embodiments of this invention there is provided a computer program product that comprises computer executable program instructions embodied in a tangible storage medium, the execution of the instructions resulting in operations that comprise, in response to a user-generated input, operating a calendar application to access an electronic calendar to cancel at least one scheduled event; and generating information for use in contacting at least one party associated with the cancelled at least one scheduled event.

Further in accordance with the exemplary embodiments of this invention there is provided a device that includes a user interface, a calendar application functional module coupled to the user interface, and a memory storing a calendar and an address book. The calendar application functional module is configured to operate in response to an input received from the user interface to access the calendar to cancel at least one scheduled event and to access the address book to generate information for use in contacting at least one party associated with the cancelled at least one scheduled event.

Further in accordance with the exemplary embodiments of this invention there is provided a user interface that includes display means and input means, and configured to implement a calendar interrupt function in cooperation with a calendar application. A first activation of the user input means triggers the calendar application to automatically cancel at least one next scheduled event in an electronic calendar, and to generate information for use in informing a party affected by the cancellation of the at least one next scheduled event of the cancellation.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram an embodiment of a wireless communications system having devices that are suitable for practicing the exemplary embodiments of this invention.

FIG. 2 is a block diagram showing a calendar application and functional module configured in accordance with the exemplary embodiments of this invention.

FIG. 3 is a logic flow diagram that illustrates a method and the operation of a computer program product in accordance with the exemplary embodiments of this invention.

### DETAILED DESCRIPTION

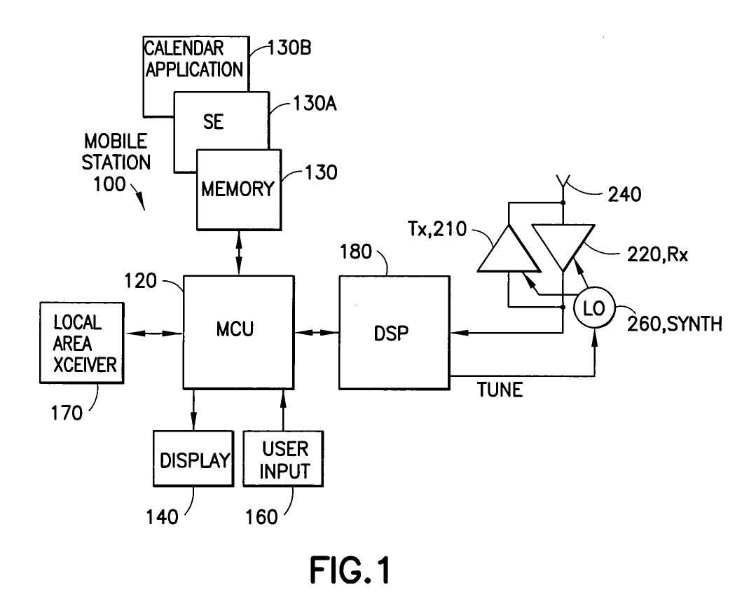

Referring to FIG. 1 there is shown as a simplified block diagram an embodiment of a device, such as a wireless communications device or mobile station 100, that is suitable for practicing the exemplary embodiments of this invention.

It should first be noted that while the exemplary embodiments of the invention will be shown and described as being practiced in a wireless communications terminal, in general the teachings of this invention apply to any type of electronic device that is capable of hosting a calendar/scheduling application software. Thus, the exemplary embodiments of this invention may be used in desktop computers and workstations, laptop computers, notebook computers and personal digital assistants (PDAs), to name just a few of the many possible devices that can benefit from the use of the exemplary embodiments of this invention. As such, it should be appreciated that the description of the MS 100 in FIG. 1 is not intended to be read in any way as a limitation upon the use and possible implementations of the exemplary embodiments of this invention.

Still referring to FIG. 1, the mobile station 100 typically includes a control unit or control logic, such as a microcontrol unit (MCU) 120 having an output coupled to an input of a display 140 and an input coupled to an output of a user input 160, such as a real or virtual keyboard or keypad and that may include some type of pointing device such as, but not limited to, a stylus, a mouse or a touch-sensitive display screen. The mobile station 100 may be a handheld radiotelephone, such as a cellular telephone or a personal communicator. The mobile station 100 could also be contained within a card or module that is connected during use to another device. For example, the mobile station 100 could be contained within a PCMCIA or similar type of card or module that is installed during use within a portable data processor, such as a laptop or notebook computer.

In general, the various embodiments of the MS 100 can include, but are not limited to, cellular telephones, personal digital assistants (PDAs) and portable computers, and may include or incorporate, as non-limiting examples, image capture devices such as digital cameras, gaming devices, music storage and playback appliances, Internet appliances permitting Internet access and browsing, as well as units or terminals that incorporate combinations of such functions.

The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the MCU 120 to execute the software routines, layers and protocols required to implement the methods in accordance with the exemplary embodiments of this invention, as well as to provide a suitable user interface (UI), via display 140 and user input 160, with a user. Although not shown, a microphone and speaker may be provided for enabling the user to conduct voice calls in a conventional manner.

Stored in the memory 130 is assumed to be a data structure that is descriptive of at least one scheduled event (SE) 130A, such as meetings. The SE data structure 130A is established, managed and used in accordance with the exemplary embodiments of this invention. Associated with the SE 130A is a scheduled event application, which may be referred to for convenience as a calendar application 130B. The calendar application 130B comprises computer executable program code that interacts with the data structure that is descriptive of the SE 130A, and is suitable for use in implementing the exemplary embodiments of this invention, as described more fully below.

The mobile station 100 also typically contains a wireless section that includes a digital signal processor (DSP) 180, or equivalent high speed processor or logic, as well as a wireless transceiver that includes a transmitter 200 and a receiver 220, both of which are coupled to at least one antenna 240 for communication with a network operator. At least one local oscillator, such as a frequency synthesizer (SYNTH) 260, is provided for tuning the transceiver. Data, such as digitized voice and packet data, is transmitted and received through the antenna 240. The wireless section may be considered to function as a long range interface (e.g., hundreds or thousands of meters) to a base station coupled to a communications network, such as a cellular operator network and/or the Internet. Note that the MS may also include a local area wireless transceiver (Xceiver) 170, such as one based on Bluetooth™ low power RF or infrared (IR) technology. The local area transceiver 170 may be considered as a short range interface (e.g., meters or tens of meters) for coupling to a wireless local area-network (WLAN) via a suitable access point.

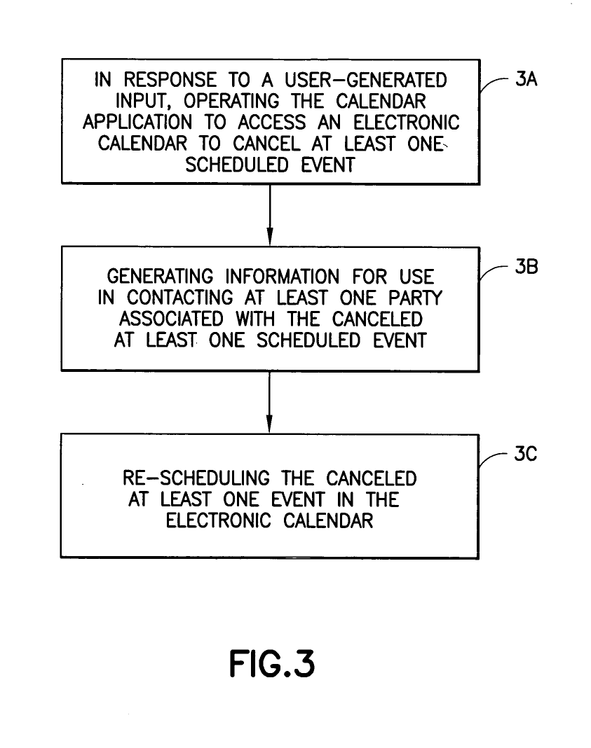

The exemplary embodiments of this invention may be implemented by computer software (e.g., the calendar application 130B) executable by a data processor of the mobile station 100, such as the processor 120, or by hardware, or by a combination of software and hardware. Further in this regard it should be noted that the various blocks of the logic flow diagram of, for example, FIG. 3 (described below) may represent program steps, or interconnected logic circuits, blocks and functions, or a combination of program steps and logic circuits, blocks and functions.

The memory 130 may be of any type suitable to the local technical environment and may be implemented using any suitable data storage technology, such as semiconductor-based memory devices, magnetic memory devices and systems, optical memory devices and systems, fixed memory and removable memory. The data processor(s) 120, 180 may be of any type suitable to the local technical environment, and may include one or more of general purpose computers, special purpose computers, microprocessors, digital signal processors (DSPs) and processors based on a multi-core processor architecture, as non-limiting examples.

In general, the various exemplary embodiments may be implemented in hardware or special purpose circuits, software, logic or any combination thereof. For example, some aspects of the exemplary embodiments of this invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

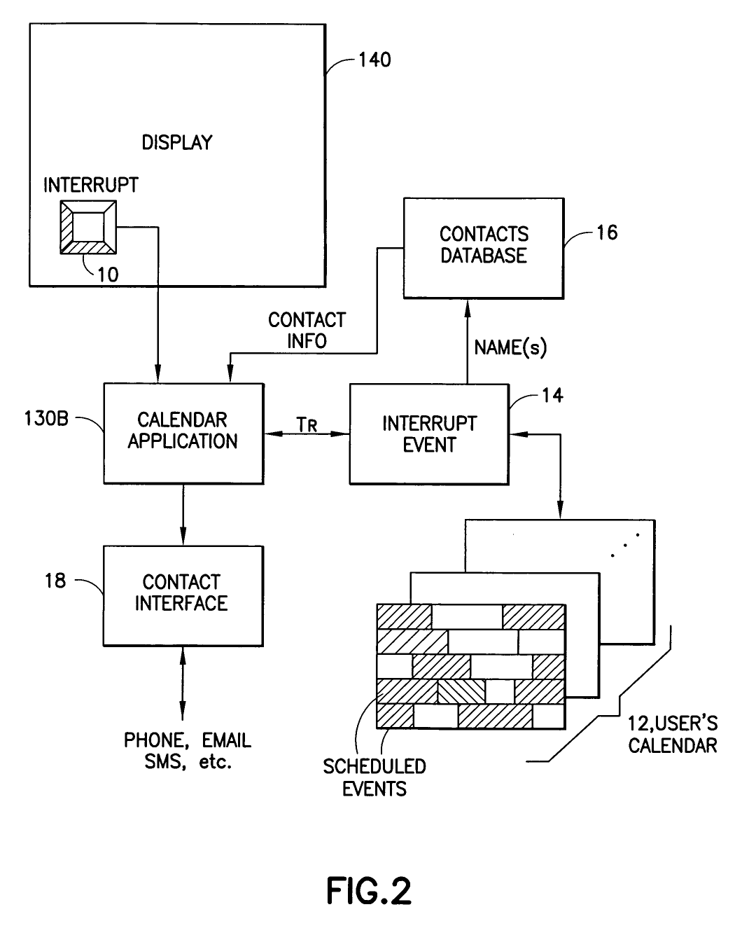

Referring to FIG. 2, and in accordance with exemplary embodiments of this invention, the user interface 140, 160 is constructed to include an interrupt button 10 (a calendar interrupt button) that can be readily accessed by the user, as well as a corresponding calendar event 12. The interrupt button 10 may be a physical button (a hard or soft key) or a virtual button that can be highlighted and clicked on, or otherwise selected (e.g., the display 140 may be a touch screen display, as shown in the non-limiting embodiment of FIG. 2). An output of the interrupt button 10 is coupled to the calendar application 130B which monitors the button state, and when it detects that the button 10 has been activated by the user it generates a trigger (Tr) to a calendar interrupt event 14. The calendar interrupt event 14 operates on the calendar 12 to automatically cancel any pending scheduled events and to re-schedule them (if possible) for a later period, such as during a currently unscheduled block of time on the same day or a later day.

For example, assume that the user becomes ill in the morning and clicks the interrupt button 10 to interrupt the calendar 12 for the day, or an important guest arrives unannounced and the user wishes to interrupt his calendar for the remainder of the afternoon. The user may also be provided with a ‘do not disturb’ type of interrupt which clears the calendar 12 for some pre-defined period of time, and then continues to clear the calendar 12 until the interrupt is removed by the user. For the purposes of this disclosure the calendar interrupt and the ‘do not disturb’ interrupt may be collectively referred to simply as a calendar interrupt, or even more simply as an interrupt.

The activation of the interrupt button 10 may be coupled with the user entering a period of time, e.g., three hours, after which the calendar application 130B automatically reverts to normal operation, similar to a one-shot type of timer operation. Alternatively, the activation of interrupt button 10 may trigger an interrupt period that remains in effect until the user again activates the interrupt button 10. It should be appreciated that a number of various user interface options may exist in this regard. As one non-limiting example, multiple repeated depressions of the interrupt button 10 may be interpreted by the calendar application 130B as specifying a corresponding number of successive periods of time, e.g., three successive depressions of the interrupt button 10 may be interpreted as requesting an interrupt period of three hours (one hour per depression). Note that of no specific amount of time is specified for the interrupt duration then the calendar application 130B may periodically trigger the interrupt event 14, such as every 30 minutes, so that a next scheduled event (one scheduled to begin within the next 30 minutes) can be cancelled, possibly re-scheduled and a proper notification sent to the affected party or parties as discussed below.

Another function of the interrupt event 14 is to retrieve from the cancelled/re-scheduled events in the calendar 12 a list of names of affected parties (e.g., persons, a business or service provider where the user had scheduled an appointment). The interrupt event 14 may retrieve all such names, or only those previously designated by the user as being important. The list of names may then be provided to a contacts database 16 (e.g., an electronic address book maintained by the MS 100) to obtain the associated contact information, such as telephone numbers and/or email addresses. Note that all affected person's names may be provided to the contacts database 16, which may include an importance designation (status designation) for that person. In this manner the contact information for only those persons marked as important or essential is returned and/or otherwise acted on by the calendar application 130B. For example, if a particular calendar entry lists a meeting with Mary, Paul and Sam, and if Mary's contact information in the contact's database 16 includes her status as the team leader, then the notification of the cancelled/postponed meeting may only be sent to Mary.

Depending on the circumstances, the list of names and telephone numbers may be displayed to the user for enabling the user to telephone each affected party to inform them of the event cancellation/rescheduling (the time and date of the cancelled and rescheduled events may also be displayed). A default email text (or short message service (SMS) text) may also be composed for sending to the affected parties, either automatically or under control of the user. As one non-limiting example, this text could include: “I have had to cancel our meeting on ______ at ______. It has been tentatively rescheduled for ______ at ______. Please let me know if this is an acceptable date and time.”, where the underscored fields may be automatically filled in by the calendar application 130B in cooperation with the interrupt event 14. To this end the calendar application 130B may be coupled to a contact interface 18, which may include one or both of the long range transceiver 210, 220 and the short range (local area) transceiver 170, for sending the necessary telephonic or other message types.

Note further in this regard that the calendar application 130B may automatically send a cancellation/rescheduling message (an invitation) directly to a calendar application of the person (or business/service provider, e.g., a dentist) to be contacted for a case where the person's (or business/service provider) calendar application is enabled and configured to automatically respond to such a message so as to check the person's (or business/service provider) calendar entries for a conflict and to automatically respond with an acceptance or a rejection (as well as to automatically reschedule the postponed meeting or appointment or other event). It may be assumed that the calendar application 130B includes such a capability. The calendar invitation may be sent (and received) via the contact interface 18, such as through one or both of the long range transceiver 210, 220 and the short range (local area) transceiver 170.

In accordance with the exemplary embodiments of this invention the user interface 140, 160 can be operated to make the interrupt button 10 visible on a first-level display menu, and the calendar application 130B is configured to review the calendar 12 entries affected by the interrupt and to cancel/postpone these events, while also notifying some or all affected persons directly (e.g., by phone, by email), or more indirectly, such as via their respective calendar applications. By the use of the exemplary embodiments of this invention the calendar user is enabled to react quickly to sudden events that impact the calendar schedule, and can further rely on the calendar application 130B to sort out the consequences. The user may be provided with a list of important parties phone numbers to facilitate calling them if there is a need to personally cancel/explain the cancellation/rescheduling.

Thus, the exemplary embodiments of this invention provide an interrupt button/function and/or a do not disturb button/function that is associated with a calendar user interface.

Based on the foregoing it should be appreciated that non-limiting aspects of this invention relate to a method and to a computer program product to operate the calendar application 130B. As is shown in FIG. 3, the method and computer program product operate by, (Block 3A) in response to a user-generated input, operating the calendar application to access an electronic calendar to cancel at least one scheduled event; and (Block 3B) generating information for use in contacting at least one party associated with the cancelled at least one scheduled event. In accordance with exemplary embodiments the generated information may comprise a telephone number that can be displayed to the user, or an address obtained for use in sending an electronic message to the at least one party, or information for use in sending a notification to another calendar application associated with the at least one party. The method may further comprise (Block 3C) the calendar application re-scheduling the cancelled at least one event in the electronic calendar.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate. Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting embodiments a full and informative description of the invention. However, various modifications and adaptations may become apparent to those skilled in the relevant arts in view of the foregoing description, when read in conjunction with the accompanying drawings and the appended claims.

For example, while described above in at least one non-limiting example as the Calendar Application 130B displaying calendar-related information on the display 140, in other embodiments a remote display could be used, i.e., the calendar application and display need not be co-located in the same device or unit. Also, it should be realized that the exemplary embodiments of this invention can be used with any type of scheduled event, including meetings, concerts, dinner engagements and the like. Furthermore, the interrupt button 10 can be implemented using any suitable technology, including the physical and virtual buttons described above, as well as with a speech recognition user input function and, in general, with any type of input device that responds to a user to generate a detectable signal to the calendar application 130B. Thus, all modifications of the teachings of this invention will still fall within the scope of this invention.

In addition, it is pointed out that while the exemplary embodiments of this invention have been primarily disclosed in the context of a mobile device (e.g., the MS 100), such as a mobile communication device, the exemplary embodiments may be employed as well in, as non-limiting examples, PC-based and web-based calendar applications. For example, a PC may initiate (or terminate) a mobile phone call (or an IP call, such as a VoIP call) on behalf of a user. That is, all of the exemplary embodiments described above may be embodied in any of a number of device types and systems, and are not intended to be limited in any way to any specific type of device or system.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
in response to a user-generated input, operating a calendar application to access an electronic calendar to cancel at least one scheduled event; and
generating information for use in contacting at least one party associated with the cancelled at least one scheduled event.

2. The method of claim 1, where the generated information comprises a telephone number, and further comprising displaying the telephone number to the user.

3. The method of claim 1, where the generated information comprises an address obtained for use in sending an electronic message to the at least one party.

4. The method of claim 1, where the generated information is obtained for use in sending a notification to another calendar application associated with the at least one party.

5. The method of claim 1, further comprising the calendar application re-scheduling the cancelled at least one event in the electronic calendar.

6. The method of claim 1, where calendar application accesses the electronic calendar to cancel a plurality scheduled events scheduled to occur within a predetermined period of time.

7. The method of claim 1, where calendar application accesses the electronic calendar to cancel a succession of scheduled events until another user-generated input is received.

8. The method of claim 1, where the calendar application is resident in a mobile device, where the user-generated input is received from user input means of the wireless device, and where the information is used to contact the at least one other party through one of a short range wireless link and a long range wireless link.

9. The method of claim 1, further comprising the calendar application re-scheduling the cancelled event in the electronic calendar, and where the generated information is used for sending an invitation to another calendar application associated with the at least one party, the invitation comprising a notification of the cancellation of the scheduled event and information descriptive of the re-scheduled event.

10. A computer program product comprising computer executable program instructions embodied in a tangible storage medium, the execution of the instructions resulting in operations that comprise:
in response to a user-generated input, operating a calendar application to access an electronic calendar to cancel at least one scheduled event; and
generating information for use in contacting at least one party associated with the cancelled at least one scheduled event.

11. The computer program product of claim 10, where the generated information comprises a telephone number obtained from a contacts database, and further comprising displaying the telephone number to the user.

12. The computer program product of claim 10, where the generated information comprises an address obtained from a contacts database for use in sending an electronic message to the at least one party.

13. The computer program product of claim 10, where the generated information is obtained from a contacts database for use in sending a notification to another calendar application associated with the at least one party.

14. The computer program product of claim 10, further comprising the calendar application attempting to re-schedule the cancelled at least one event in the electronic calendar.

15. The computer program product of claim 10, where calendar application accesses the electronic calendar to cancel a plurality scheduled events that are scheduled to occur within a predetermined period of time.

16. The computer program product of claim 10, where calendar application accesses the electronic calendar to cancel a succession of scheduled events until another user-generated input is received.

17. The computer program product of claim 10, where the calendar application is resident in a mobile device, where the user-generated input is received from a user input means of the wireless device, and where the information is used to contact the at least one other party through one of a short range wireless link and a long range wireless link.

18. The computer program product of claim 10, further comprising the calendar application re-scheduling the cancelled event in the electronic calendar, and where the generated information is used for sending an invitation to another calendar application associated with the at least one party, the invitation comprising a notification of the cancellation of the scheduled event and information descriptive of the re-scheduled event.

19. A device, comprising a user interface, a calendar application functional module coupled to said user interface, and a memory storing a calendar and an address book, said calendar application functional module configured to operate in response to an input received from said user interface to access said calendar to cancel at least one scheduled event and to access said address book to generate information for use in contacting at least one party associated with the cancelled at least one scheduled event.

20. The device of claim 19, where the generated information comprises a telephone number obtained from said address book and displayed using said user interface.

21. The device of claim 19, where the generated information comprises an address obtained from said address book, further comprising a communications interface for sending an electronic message to the at least one party using the address.

22. The device of claim 19, further comprising a communications interface, and where the generated information is used to send a notification, via said communications interface, to another calendar application functional module associated with the at least one party.

23. The device of claim 19, said calendar application functional module further configured to re-schedule the cancelled at least one event in the calendar.

24. The device of claim 19, said calendar application functional module configured to access the calendar to cancel a plurality scheduled events that are scheduled to occur within a predetermined period of time.

25. The device of claim 19, said calendar application functional module configured to access the calendar to cancel a succession of scheduled events until another input is received.

26. The device of claim 19, embodied in a mobile communication device where the information is used to contact the at least one other party through one of a short range wireless link and a long range wireless link.

27. The device of claim 19, said calendar application functional module further configured to re-schedule the cancelled event in the calendar, and where the generated information is used to send an invitation to another calendar application functional module associated with the at least one party, the invitation comprising a notification of the cancellation of the scheduled event and information descriptive of the re-scheduled event.

28. The device of claim 19, where said calendar application functional module is embodied at least in part in an integrated circuit.

29. A user interface, comprising display means and input means and configured to implement a calendar interrupt function in cooperation with a calendar application, where a first activation of the user input means triggers said calendar application to automatically cancel at least one next scheduled event in an electronic calendar, and to generate information for use in informing a party affected by the cancellation of the at least one next scheduled event of the cancellation.

30. The user interface of claim 29, where the calendar application automatically cancels a plurality of next scheduled events until a second activation of said user input means.

31. The user interface of claim 29, where the calendar application automatically cancels a plurality of next scheduled events scheduled to occur within a predetermined period of time.

32. The user interface of claim 29, where the calendar application automatically cancels a plurality of next scheduled events scheduled to occur within a period of time specified by a user.

33. The user interface of claim 29, where said calendar application displays on said user interface at least some of the generated information to the user for enabling the user to directly contact the party affected by the cancellation.

34. The user interface of claim 29, where said calendar application automatically re-schedules the cancelled at least one next scheduled event.

35. The user interface of claim 29, where said calendar application is further configured to automatically reschedule the at least one cancelled event, and to automatically inform the party affected by the cancellation of the cancellation of the event and also of the re-scheduling of the event.

36. The user interface of claim 29, where the information generated for informing the party is generated by retrieving at least one name from a cancelled electronic calendar entry, and applying the name to a contacts database to retrieve a corresponding telephone number.

37. The user interface of claim 29, where the information generated for informing the party is generated by retrieving at least one name from a cancelled electronic calendar entry, and applying the name to a contacts database to retrieve a corresponding address to which an electronic message can be sent.

38. The user interface of claim 29, where the information generated for informing the party is generated by retrieving at least one person's name associated with a cancelled electronic calendar entry, applying the name to a contacts database, and selectively generating the information or not generating the information depending on a status indicated for that person.
